(19) United States
(12) Patent Application Publication
(10) Pub. No.: US 2011/0012839 A1
(43) Pub. Date: Jan. 20, 2011

(54) STACKING ASSEMBLY OF A TOUCH PANEL

(76) Inventor: Teh-Zheng Lin, Taoyuan (TW)

Correspondence Address: Teh-Zheng Lin, 235 Chung - Ho Box 8-24, Taipei, 235, TW

(21) Appl. No.: 12/503,858

(22) Filed: Jul. 16, 2009

(51) Int. Cl. G06F 3/041

(52) U.S. Cl. 345/173; 178/18.01

(57) ABSTRACT

A stacking assembly of a touch panel includes a touch sensing unit arranged insulated between a top plate and a substrate. The top plate and the substrate are transparent optical isotropic plates, and light regulating layers are arranged above separately. The light regulating layer is formed by one or a combination of a polarized thin film, phase shift thin film, and optical isotropic film. A color frame is arranged to a peripheral of a bottom surface of one optical thin film of the light regulating layer. A functional film of a nebulizing film or hard coat layer is formed to an outer optical film of the light regulating layer.

### FIELD OF THE INVENTION

The present invention relates to touch panel assembly, and particular to a stacking assembly with smooth appearance and function of dizzy-proof.

### DESCRIPTION OF THE PRIOR ART

With the rapid advancement of the panel technology, touch panels nowadays have substantially improvement in quality but have lower price so that it is widely applied to consuming electronics such as mobile phone, digital camera, media player (MP3), personal digital assistor (PDA), and global positioning system (GPS). On these electronic devices, touch panels are arranged in front of the display for users to perform input so as to improve operating efficiency and make the interface friendly. However, the operation of the touch panel strongly depends on the environment. For example, when operating the touch panel under illuminating of sunlight, irregular reflection from the surface of the panel will dizzy the user so that the content on the display is not identified or visible. Moreover, prior touch panel is fixed to a display by pressing a peripheral of the touch panel with a frame. Although the frame can also cover signal wires on edges of the touch panel so as to improve the appearance, dust will be deposited in the gap between the panel and the frame. The dust will easily cause malfunction of panel because of the fragile signal wire is easily damaged.

### SUMMARY OF THE PRESENT INVENTION

Accordingly, the primary object of the present invention is to provide an improved assembly of the touch panel. The panel will not dizzy user's eye by correcting the transmitting lights through the light regulating layers formed on surfaces of a top plate and substrate of the touch panel. The color frame formed to a peripheral of the light regulating layer of the top plate will improve an appearance of the assembly and simplify the process and save a cost.

To achieve above object, the present invention provides a stacking assembly of a touch panel comprising a touch sensing unit arranged insulated between a top plate and a substrate; sensing signals being transmitted to a signal processing circuit through signal wires formed on edges of the touch sensing unit; the top plate and the substrate being transparent optical isotropic plates; a first light regulating layer made of one or a combination of optical thin film being formed to a surface of the top plate; a color frame being arranged to a peripheral of a bottom surface of one optical thin film of the first light regulating layer.

The top plate and the substrate are optical isotropic plates which made of one of glass, Polycarbonate (PC), Ployethersulfone (PES), polymethyl methacrylate (PMMA), or Cyclo-Olefin Copolymers (COC). The first light regulating layer is formed by one or a combination of a polarized thin film, phase shift thin film, and optical isotropic film. The films of the first light regulating layer is glued by a pressure sensitive adhesive (PSA). The color frame is an opaque or a nearly opaque thin film made of one of ink, color photo resistance, organic material, or inorganic material by method of one of printing, spreading, or metal evaporating. The color frame is a thin film with a thickness about 1 to 12 μm. A second light regulating layer made of one or a combination of optical thin film is formed to a surface of the substrate. The second light regulating layer is formed by one or a combination of a polarized thin film, phase shift thin film, and optical isotropic film. The films of the second light regulating layer is glued by the pressure sensitive adhesive (PSA). A functional film is formed to an outer optical film of the first light regulating layer. The functional film is a nebulizing film. The functional film is a hard coat layer.

The light regulating layers can prevent the strong reflection of light offending to the eyes, and improve a contrast of the image. The visibility of the LCD display will be improved especially in the outdoor. Moreover, the color frame can take the place of a covering frame of the prior touch panel so as to simplify the assembly process and to save the cost. Also, a flat and smooth surface will improve an appearance.

Furthermore, a functional film is arranged to an upper surface of the optical film of the first light regulating layer. For example, a nebulizing film serves to lower the reflection of lights, or a hard coat layer made of high hardness UV coating serves to improve the hardness against scratching and rubbing.

The various objects and advantages of the present invention will be more readily understood from the following detailed description when read in conjunction with the appended drawing.

### BRIEF DESCRIPTION OF THE DRAWINGS

FIG. 1 is a cross-section view showing the stacking assembly of a first embodiment of the present invention.

FIG. 2 is a cross-section view showing the stacking assembly of a second embodiment of the present invention.

FIG. 3 is a cross-section view showing the stacking assembly of a third embodiment of the present invention, and

FIG. 4 is a cross-section view showing the stacking assembly of a fourth embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

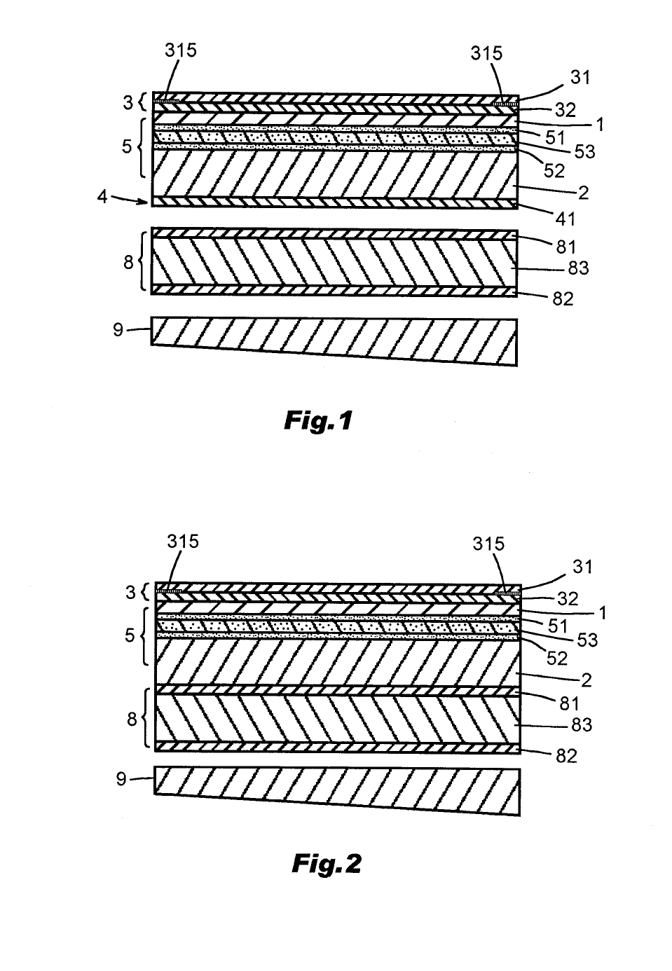

Referring to FIG. 1, a preferable embodiment of the present invention is shown. The embodiment in the following is applied in a capacitive touch panel. However, the present invention is not only applicable in the capacitive touch panel, it can also be applied to a resistive touch panel or an electromagnetic touch panel. In the embodiment of the present invention, a capacitive touch sensing unit 5 is insulated arranged between a top plate 1 and a substrate 2. On surfaces of the top plate and the substrate, light regulating layers 3 and 4 consist of at least one optical film are formed separately. Above stacking processes are using Pressure Sensitive Adhesive (PSA) instead of conventional resin glue. The stacking plates will not deform or shift by heat stress because the PSA is elastically and capable of releasing stress.

The capacitive touch sensing unit 5 includes an X axis inducting layer 51, Y axis inducting layer 52 and an insulating layer 53. The insulating layer 53 is arranged insulated between the two inducting layers, the two inducting layers are grounded separately and conducted to a control circuit (not shown). The inducting layers are made of Indium Tin Oxide (ITO). The inducting layers 51, 52 and the insulating layer 53 are transparent thin films. When a user touches a certain position on the touch sensing unit 5 by a finger or conductor, a capacitive signal will be generated so that the position will be located by sensing the variation of the capacitive signal.

The top plate 1 and the substrate 2 are transparent optical isotropic plates which are made of glass, polymethyl methacrylate (PMMA), Ployethersulfone (PES), or Cyclo-Olefin Copolymers (COC). Such plates can prevent the incident lights being polarized and are matching to the ITO thin film of the inducting layers 51 and 52.

The light regulating layer 3 on the top plate 1 includes a polarized thin film 31 and a phase shift thin film 32, and the light regulating layer 4 on the substrate 2 is a phase shift thin film 41. The polarized thin film 31 is made by a Polyvinyl alcohol (PVA) film glued by two Triallyl Cyanurate (TAC) films. The stretched PVA film is capable of forming double refractions. A thickness of the PVA film is about 15 to 30 μm. A thickness of the PVA film is 140 to 180 μm. The phase shift thin films 32 and 41 are made of Polycarbonate (PC).

A Liquid Crystal Display (LCD) display 8 is arranged below the substrate 2 of the touch panel. The display 8 has a prior assembly of a liquid crystal chamber 83 formed between two polarized films 81 and 82, and a back light source 9 is arranged below the display 8 so as to provide illumination for the display 8.

By the polarized thin film and the phase shift thin film formed on the top plate 1 and the substrate 2 of the touch panel, incident lights will be refracted inside the touch panel without going out so that it is not harsh to the eyes of a user outdoor. While the lights coming out from the back light source 9 can be projected out of the display 8 without being blocked by the polarized thin film 31 and the phase shift thin film 32 so that the sufficient illumination can help the visibility. By the light regulating layers 3 and 4, the visibility of the LCD display 8 can also be improved.

Besides, a color frame 315 is arranged on a peripheral of a bottom surface of the polarized film 31. The frame 315 is an opaque or a nearly opaque ink coating. The ink coating with a thickness of 2 μm is formed by printing or coating. The color frame 315 can take the place of a decorating frame of the touch panel so as to simplify the assembly process and to save the cost. Also, a flat and smooth surface will improve an appearance.

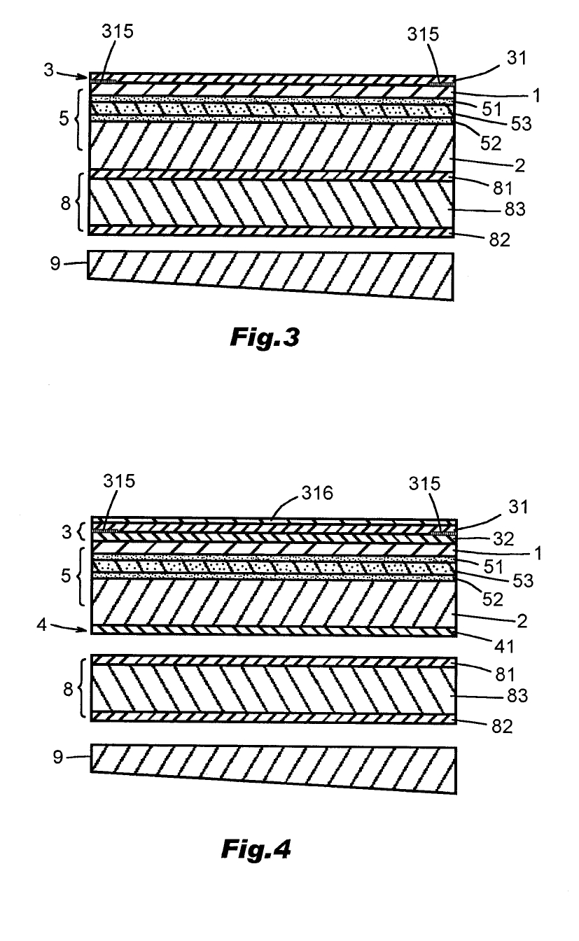

However, the arrangement of the light regulating layers 3 and 4 is adjustable according to the operating conditions. For example, a second embodiment of the present invention illustrated in FIG. 2 still has a light regulating layer 3 with the polarized film 31 and the phase shift thin film 32 on the top plate 1, but the light regulating layer 4 is removed from the bottom surface of the substrate 2. Referring to FIG. 3, a third embodiment of the present invention has the light regulating layer 3 with only the polarized film 31 on the top plate 1, and the light regulating layer 4 is removed from the bottom surface of the substrate 2. The color frame 315 is still arranged to the bottom surface of the polarized film 31 in the second and the third embodiments so as to improve the appearance. The dizzy-proof function and visibility under such modifications is inferior to that of the first embodiment, but it is still acceptable when operating indoor or not being directly illuminating by sunlight.

Moreover, a fourth embodiment of the present invention is illustrated in FIG. 4. The assembly of the embodiment is nearly identical to that of the first embodiment. On an upper surface of the polarized film 31, an additional nebulizing film 316 is arranged so as to lower the reflection of lights. Or, a hard coat layer 316 made by high hardness UV coating is arranged so as to improve the hardness against scratching and rubbing. The touch panel will have better performance and durability with above modifications on the outer surface thereof.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A stacking assembly of a touch panel comprising a touch sensing unit arranged insulated between a top plate and a substrate; sensing signals being transmitted to a signal processing circuit through signal wires formed on edges of the touch sensing unit; the top plate and the substrate being transparent optical isotropic plates; a first light regulating layer made of one or a combination of optical thin film being formed to a surface of the top plate; a color frame being arranged to a peripheral of a bottom surface of one optical thin film of the first light regulating layer.

2. The stacking assembly of a touch panel as claimed in claim 1, wherein the top plate and the substrate are optical isotropic plates which made of one of glass, Polycarbonate (PC), Ployethersulfone (PES), polymethyl methacrylate (PMMA), or Cyclo-Olefin Copolymers (COC).

3. The stacking assembly of a touch panel as claimed in claim 1, wherein the first light regulating layer is formed by one or a combination of a polarized thin film, phase shift thin film, and optical isotropic film.

4. The stacking assembly of a touch panel as claimed in claim 1, wherein the films of the first light regulating layer is glued by a pressure sensitive adhesive (PSA).

5. The stacking assembly of a touch panel as claimed in claim 1, wherein the color frame is an opaque or a nearly opaque thin film made of one of ink, color photo resistance, organic material, or inorganic material by method of one of printing, spreading, or metal evaporating.

6. The stacking assembly of a touch panel as claimed in claim 1, wherein the color frame is a thin film with a thickness about 1 to 12 μm.

7. The stacking assembly of a touch panel as claimed in claim 1, wherein a second light regulating layer made of one or a combination of optical thin film is formed to a surface of the substrate.

8. The stacking assembly of a touch panel as claimed in claim 7, wherein the second light regulating layer is formed by one or a combination of a polarized thin film, phase shift thin film, and optical isotropic film.

9. The stacking assembly of a touch panel as claimed in claim 8, wherein the films of the second light regulating layer is glued by the pressure sensitive adhesive (PSA).

10. The stacking assembly of a touch panel as claimed in claim 1, wherein a functional film is formed to an outer optical film of the first light regulating layer.

11. The stacking assembly of a touch panel as claimed in claim 10, wherein the functional film is a nebulizing film.

12. The stacking assembly of a touch panel as claimed in claim 10, wherein the functional film is a hard coat layer.
